(19) United States
(12) Patent Application Publication
(10) Pub. No.: US 2014/0115536 A1
(43) Pub. Date: Apr. 24, 2014

(54) DISPLAY PROGRAM AND DISPLAY DEVICE

(71) Applicants: Hiroyuki Akiya, New York, NY (US); Naotaka Yamashita, Kawasaki-shi (JP); Kensuke Kanamaru, Tokyo (JP); Takafumi Sekiya, Kawasaki-shi (JP)

(72) Inventors: Hiroyuki Akiya, New York, NY (US); Naotaka Yamashita, Kawasaki-shi (JP); Kensuke Kanamaru, Tokyo (JP); Takafumi Sekiya, Kawasaki-shi (JP)

(73) Assignee: NIKON CORPORATION, Tokyo (JP)

(21) Appl. No.: 14/122,584

(22) PCT Filed: Jun. 1, 2012
(86) PCT No.: PCT/JP2012/003635

§ 371 Date: Nov. 26, 2013

(30) Foreign Application Priority Data
Jun. 21, 2011 (JP) 2011-137486

(51) Int. Cl. G06F 3/0484; G06F 3/0482

(52) U.S. Cl. CPC G06F 3/04845; G06F 3/0482
USPC 715/810

(57) ABSTRACT

A user interface which is easy-to-understand and easy-to-use for the user is provided in displaying an image by a displaying program including a reading step which reads a target image to be displayed, a decision step which decides a content of a user interface for accepting various settings for the target image to be displayed on the displaying apparatus based on the target image, and a displaying step which displays the user interface on the displaying apparatus based on the content being decided in the decision step.

### CROSS-REFERENCE TO RELATED APPLICATIONS

This application is a U.S. national stage application of PCT/JP2012/003635 filed Jun. 1, 2012 and claims foreign priority benefit of Japanese Application No. 2011-137486 filed Jun. 21, 2011 in the Japanese Intellectual Property Office, the contents of both of which are incorporated herein by reference.

### TECHNICAL FIELD

The present invention relates to a displaying program and a displaying apparatus.

### BACKGROUND ART

Conventionally, various techniques have been examined with regard to image editing associated with digital images. For example, the invention of Patent Document 1 has disclosed a technique of performing image analysis on a target image of image editing, and based on the analysis result, prompting input of parameters or providing notification of appropriate parameters so that the user can select preferred image correcting parameters.
Patent Document 1: Japanese Patent No. 4114279

### DISCLOSURE

### Problems to be Solved

However, with the prior art, the user cannot select preferred parameters when the result of the image analysis is not correct. In addition, a sufficiently easy-to-understand and easy-to-use user interface is also required even for users lacking knowledge and experience.

It is a proposition of the present invention to provide, in displaying an image, a user interface which is easy for the user to understand and use.

### Means for Solving the Problems

A displaying program according to an aspect of the embodiment is the displaying program causing a computer to perform display control on a displaying apparatus which includes a reading step reading a target image to be displayed, a decision step deciding a content of a user interface for accepting various settings for the target image to be displayed on the displaying apparatus based on the target image, and a displaying step displaying the user interface on the displaying apparatus based on the content being decided in the decision step.

In the decision step, the content of the user interface may be decided based on at least one of a factor being attribute information of the target image and a factor being a shooting condition when shooting the target image.

In addition, there may be further included an analyzing step performing an image analysis of the target image, in which in the decision step, the content of the user interface may be decided based on at least one of a factor being attribute information of the target image, a factor being a shooting condition when shooting the target image, and a factor being a result of the image analysis.

Additionally, in the decision step, the factor may be at least the result of the image analysis.

Furthermore, in the decision step, the content of the user interface for accepting various settings related to editing of the target image may be decided.

Moreover, the attribute information may include at least one of the data format of the target image and the data size of the target image.

In addition, the shooting condition may include at least one of a type of shooting mode being set when shooting the target image, an exposure condition when shooting the target image, a presence or an absence of flash light emission when shooting the target image, positional information when shooting the target image, and information of an external device being connected to the imaging apparatus when shooting the target image.

Additionally, in the analyzing step, may perform at least one of a distribution analysis of brightness of the target image, a face detection detecting a face region included in the target image, a dust detection of the target image, a red-eye detection of the target image, a blur detection of the target image, a bokeh detection of the target image, a detection of tilt information of the target image, and a scene analysis of a subject included in the target image, and the result of the image analysis may include at least one of distribution information of the brightness, a result of the face detection, a result of the dust detection, a result of the red-eye detection, a result of the blur detection, a result of the bokeh detection, the tilt information, and a result of the scene analysis.

Furthermore, when deciding the content of the user interface based on the factor in a plurality in the decision step, the content of the user interface may be decided after having performed appropriate weighting on the plurality of the factors.

Moreover, in the decision step, a content of a user interface having preferred items for the various settings which are visible by a user are decided as the content of the user interface.

In addition, in the decision step, at least one of types of items related to the various settings, a display order of the items, an arrangement of the items, and a display format of the items may be decided as the content of the user interface.

Additionally, in the decision step, appropriate weighting may be performed on the items and at least one of types of items related to the various settings, a display order of the items, an arrangement of the items, and a display format of the items may be decided according to the weighting.

Additionally, in the decision step, the content of the user interface may be decided based on a content of the various settings being performed previously.

A displaying apparatus according to an aspect of the embodiment includes a displaying part displaying an image, a reading part reading a target image to be displayed on the displaying part, a decision part deciding a content of a user interface for accepting various settings for the target image to be displayed on the displaying part based on the target image, and a display controlling part displaying the user interface on the displaying part based on the content being decided by the decision part.

### BRIEF DESCRIPTION OF THE DRAWINGS

FIG. 1 is a block diagram illustrating a configuration example of a displaying apparatus in the first embodiment.

FIG. 2 is a flowchart illustrating an operation example of the displaying apparatus in the first embodiment.

FIG. 3 is a view illustrating a display example of a monitor 16 in the first embodiment.

FIG. 4 is another view illustrating a display example of the monitor 16 in the first embodiment.

FIG. 5 is a view illustrating an example of a user interface in the first embodiment.

FIG. 6 is another view illustrating an example of a user interface in the first embodiment.

FIG. 7 is another view illustrating an example of a user interface in the first embodiment.

FIG. 8 is another view illustrating an example of a user interface in the first embodiment.

FIG. 9 is another view illustrating an example of a user interface in the first embodiment.

FIG. 10 is another view illustrating an example of a user interface in the first embodiment.

FIG. 11 is a block diagram illustrating a configuration example of an electronic camera in the second embodiment.

FIG. 12 is a view illustrating an example of a user interface.

### DESCRIPTION OF EMBODIMENTS

### Description of First Embodiment

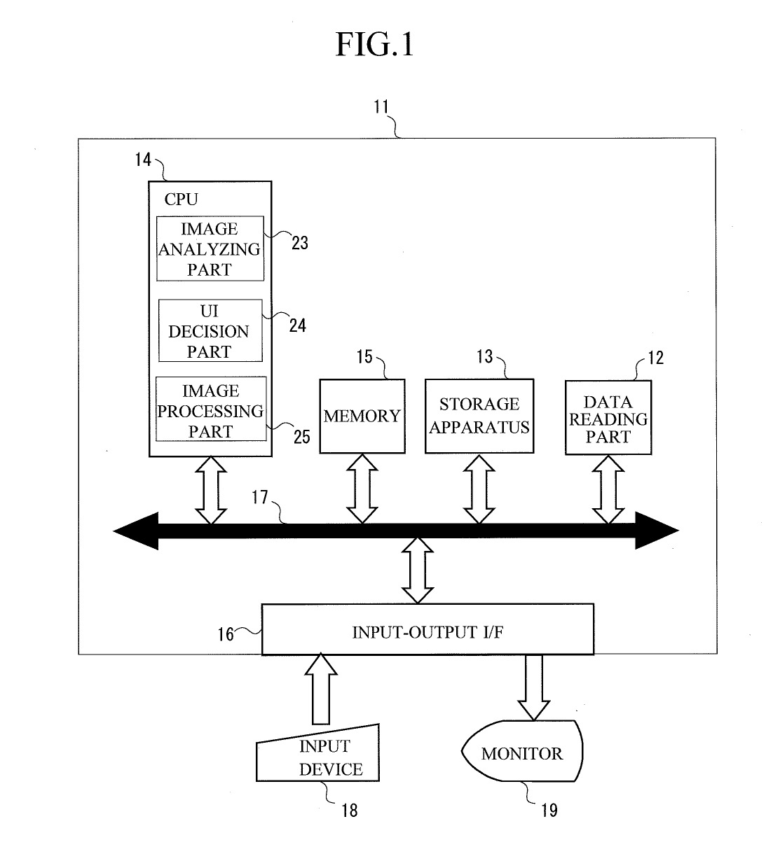

FIG. 1 is a block diagram illustrating a configuration example of a displaying apparatus in a first embodiment. The displaying apparatus of the first embodiment includes a computer having installed therein a displaying program which displays and edits an image to be processed (target image) which has been imaged by an imaging apparatus.

A computer 11 illustrated in FIG. 1 has a data reading part 12, a storage apparatus 13, a CPU 14, a memory 15, an input-output I/F 16, and a bus 17. The data reading part 12, the storage apparatus 13, the CPU 14, the memory 15, and the input-output I/F 16 are connected to each other via the bus 17. Furthermore, the computer 11 has an input device 18 (keyboard, pointing device, etc.) and a monitor 19 respectively connected thereto via the input-output I/F 16. Meanwhile, the input-output I/F 16 accepts various inputs from the input device 18, and also outputs display data to the monitor 19.

The data reading part 12 is used in reading, from the outside, data of the target image or the displaying program described above. For example, the data reading part 12 is constituted by a reading device (reading apparatus of optical disk, magnetic disk, magneto-optical disk, etc.) which obtains data from a removable storage medium, and a communication device (USB interface, LAN module, wireless LAN module, etc.) which communicates with an external device in conformity with a well-known communication standard.

The storage apparatus 13 is constituted by, for example, a storage medium such as a hard disk, a nonvolatile semiconductor memory, or the like. The storage apparatus 13 has recorded therein a displaying program and various data required for execution of the program. Meanwhile, the storage apparatus 13 can also store data of a target image which has been read from the data reading part 12.

The CPU 14 is a processor which controls each part of the computer 11 in an integrated manner. The CPU 14 functions as an image analyzing part 23, a UI decision part 24, and an image processing part 25, respectively, by execution of the image processing program described above (respective operations of the image analyzing part 23, the UI decision part 24, the image processing part 25 will be described later).

The memory 15 temporarily stores various results from the image processing program. The memory 15 includes, for example, a volatile SDRAM or the like.

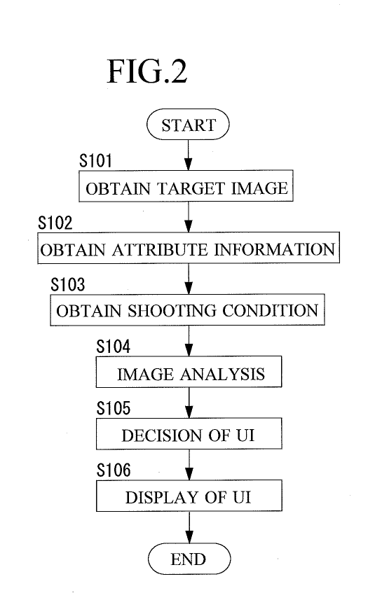

In the following, an operation example of the displaying apparatus in the first embodiment will be described, referring to the flowchart of FIG. 2. Meanwhile, the processing of the flowchart of FIG. 2 is initiated by executing the displaying program by the CPU 14, according to a program execution instruction from the user.

Each process illustrated in FIG. 2 is executed when a target image to be edited or displayed is selected by user operation via the input device 18 in a state where an image is displayed on the monitor 19. In the following, description will be provided by exemplifying a case of selecting a target image to be edited.

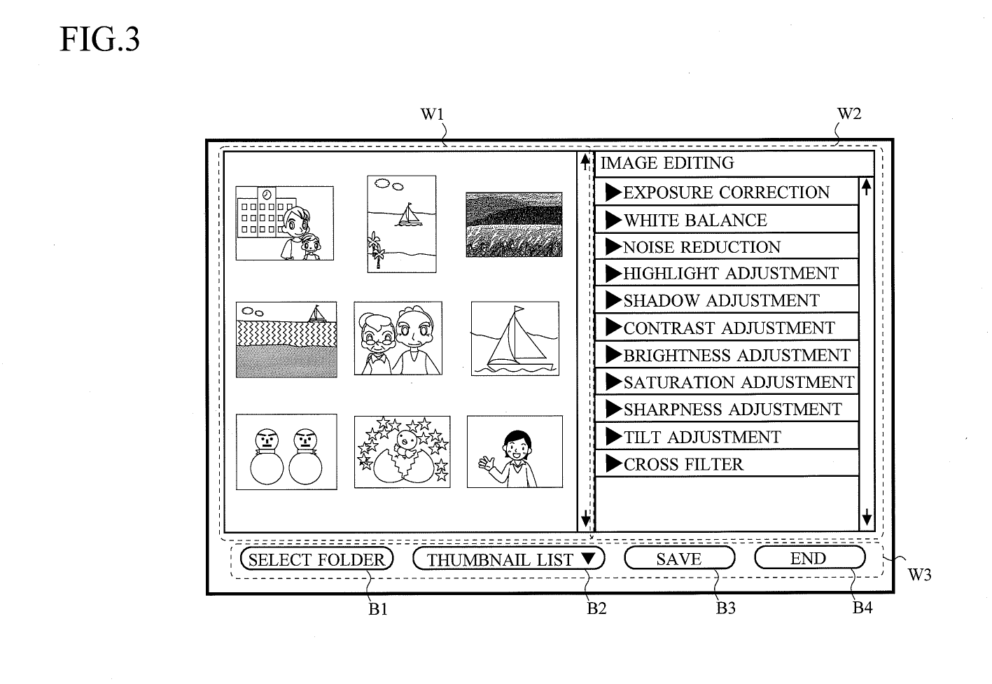

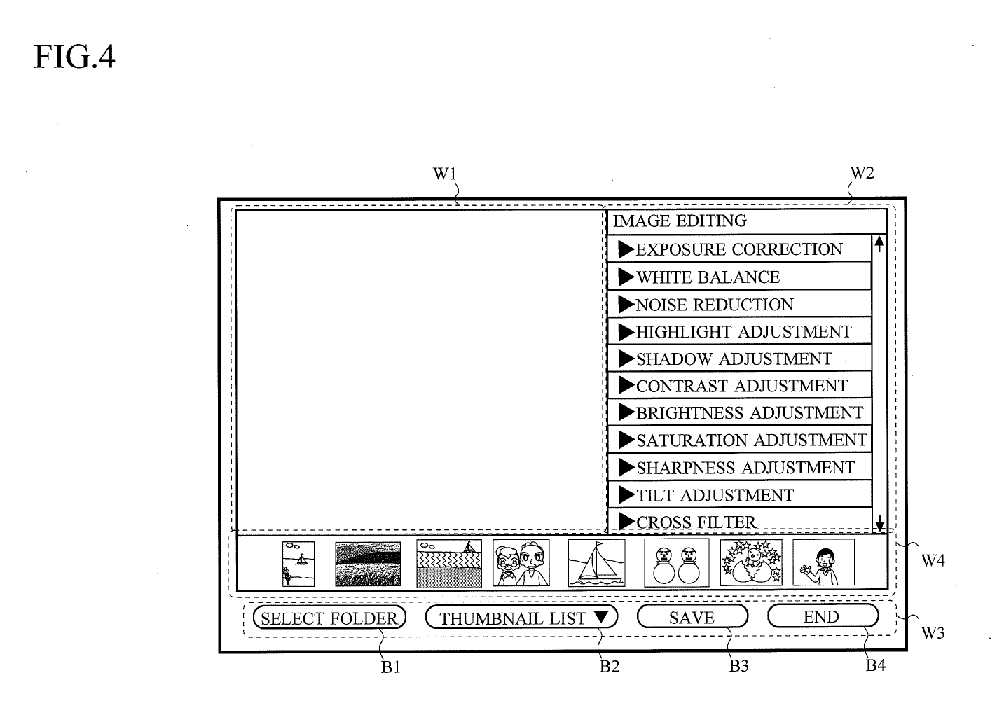

FIGS. 3 and 4 are display examples of images. FIG. 3 illustrates a display example of a list of thumbnails, and FIG. 4 illustrates an example of viewer display.

In the example of FIG. 3, thumbnail images of a plurality of images are displayed on a first window W1, a menu of respective items relating to image editing is displayed on a second window W2, and various buttons are displayed on a third window W3. The user operates various buttons of the window W3 to thereby display a plurality of thumbnail images on the window W1, and selects, via the input device 18, any image as the target image from the plurality of the thumbnail images displayed on the window W1.

In the example of FIG. 4, the first window W1 is a window which displays the selected target image in a magnified manner, the second window W2 has a menu of respective items relating to image editing displayed thereon, the third window W3 has various buttons displayed thereon, and the fourth window W4 has thumbnail images of a plurality of images displayed thereon. The user operates the various buttons of the window W3 to display a plurality of the thumbnail images on the window W4 and selects, via the input device 18, any image as the target image, from the plurality of the thumbnail images displayed on the window W4. Then, the selected target image is displayed on the window W1 in a magnified manner.

FIGS. 3 and 4 are display examples at the time of selecting the target image, and at this time point, respective menu items displayed on the window W2 are in a closed state, that is, details thereof are in a state of not being displayed (description of an opened state will be provided below). In addition, the display examples of FIGS. 3 and 4 illustrate, as respective menu items displayed on the window W2, exposure correction, white balance, noise reduction, highlight adjustment, shadow adjustment, contrast adjustment, brightness adjustment, saturation adjustment, sharpness adjustment, tilt adjustment, and cross filter.

Additionally, in the display examples of FIGS. 3 and 4, as respective buttons displayed on the window W3, a folder selecting button B1, a thumbnail list display/viewer display switching button B2, a save button B3, and an end button B4 are displayed. The folder selecting button B1 is a button for selecting a folder to be displayed among a plurality of folders, the thumbnail list display/viewer display switching button B2 is a button for switching between the thumbnail list display illustrated in FIG. 3 and the viewer display illustrated in FIG. 4, the save button B3 is a button for saving the contents of editing, and the end button B4 is a button for terminating respective displays illustrated in FIGS. 3 and 4.

Meanwhile, the displays of FIGS. 3 and 4 are each one example. For example, the size, design, arrangement, and the like of each window are not limited to these examples. In addition, the menu displayed on the window W2 is also one example and not limited to these examples. In addition, respective buttons displayed on the window W3 are each one example and not limited to these examples. In addition, the size, arrangement, and the like of the plurality of thumbnail images displayed on the window W1 or the window W4 are also not limited to the example.

In the following, description will be provided by exemplifying a case where a target image of image editing has been selected by user operation via the input device 18, in a state where the viewer illustrated in FIG. 4 is displayed. The basic processing is also similar to a case where a target image of image editing has been selected by user operation via the input device 18, in a state where the thumbnail list illustrated in FIG. 3 is displayed.

(Step S101)

The CPU 14 obtains, from the storage apparatus 13 via the data reading part 12, data of a target image specified by the user. Meanwhile, when data of the target image is recorded outside of the computer 11, the CPU 14 obtains, from outside of the computer 11 via the input-output I/F 16, data of the target image specified by the user.

(Step S102)

The CPU 14 obtains attribute information from the target image obtained at step S. The attribute information is information relating to attributes of the target image itself typically included in auxiliary information such as data format (RAW,JPEG) of the target image, data size of the target image or the like, and such as normal EXIF information.

(Step S103)

The CPU 14 obtains, from the target image obtained at step S, shooting conditions when the target image is shot. The shooting condition includes information relating to: types of shooting modes (portrait mode, scenery mode, etc.) which has been set when the target image is shot; exposure conditions (shutter speed, diaphragm, sensitivity, etc.) when the target image is shot; presence or absence of flash light emission when the target image is shot; positional information (GPS information) when the target image is shot; external devices (an external flash apparatus, communication equipment) connected to the imaging apparatus when the target image is shot, or the like. The shooting conditions may be included in auxiliary information such as EXIF information, or may be recorded as data other than the data of the target image.

(Step S104)

The CPU 14 performs, with the image analyzing part 23, image analysis of the target image obtained at step S.

The image analysis performed by the image analyzing part 23 includes the following:
Analysis of distribution with regard to brightness of the target image
Face detection which detects a face region included in the target image
Dust detection with regard to the target image
Red-eye detection with regard to the target image
Blur detection in the target image
Bokeh detection with regard to the target image
Detection of tilt information with regard to the target image
Scene analysis with regard to a subject included in the target image

Meanwhile, these image analyses are exemplary, and the image analyzing part 23 may perform image analysis other than that described above. In addition, the target of image analysis need not be the target image itself obtained at step S101. For example, image analysis may be carried out using a reduced image (thumbnail image, quick view image, etc.) recorded together with the target image, or may be carried out using an image obtained by performing predetermined thinning processing or resizing processing on the target image.

In addition, the image analysis by the image analyzing part 23 may be performed before the target image is obtained at step S101. That is, the image analysis may be preliminarily performed when the target image is shot, when the target image is recorded, or after having recorded the target image, at a timing when the processing by the image analyzing part 23 is not performed.

Although the example of FIG. 2 illustrates an example of obtaining attribute information at step S102, obtaining the shooting conditions at step S103, and performing image analysis at step S104, there may also be provided a configuration which performs at least one of these steps. The step to be performed may be selected by the CPU 14, or may be selected based on user operation via the input device 18.

(Step S105)

The CPU 14 decides, with a UI decision part 24, the user interface to be displayed on the monitor 19.

The UI decision part 24 decides the contents of the user interface to be displayed on the monitor 19, according to the attribute information obtained at step S102, the shooting conditions obtained at step S103, and the result of the image analysis performed at step S104. The user interface is a user interface preferable for editing the image selected as the target image by the user. The contents of the user interface include types of items, displaying order items, arrangement of items, display format (display size, display color, etc.) of items.

Several examples will be illustrated in the following.

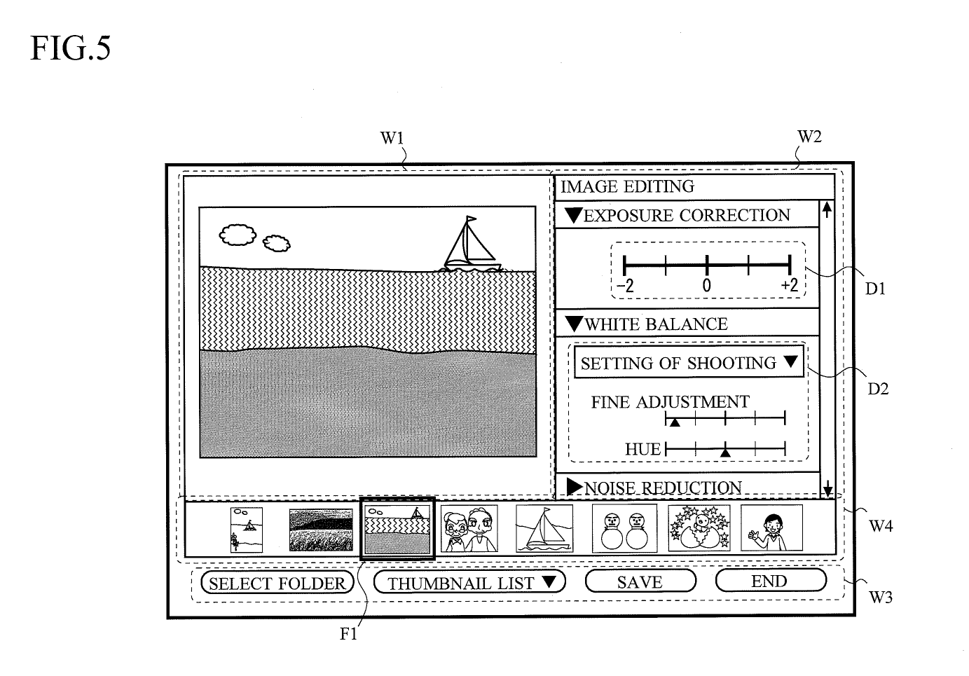

FIG. 5 illustrates an example of a user interface decided when the data format of the target image is RAW format in the attribute information obtained at step S102. In FIG. 5, a frame F1 indicating an image selected as the target image among a plurality of thumbnail images displayed on the window W4 is displayed, and also the image selected as the target image is displayed on the window W1 in a magnified manner.

When the target image is a RAW format image, image editing such as “exposure correction”, “white balance”, “noise reduction”, or the like is frequently performed and effective as well. Therefore, the UI decision part 24 selects a user interface capable of setting details of such items. FIG. 5 is a display example of the selected user interface. In the example of FIG. 5, there is displayed a slide bar D1 capable of setting the degree of exposure correction, and there is also displayed a slide bar D2 capable of setting details of white balance. That is, the items “exposure correction” and “white balance” are in an opened state in the menu displayed on the window W2.

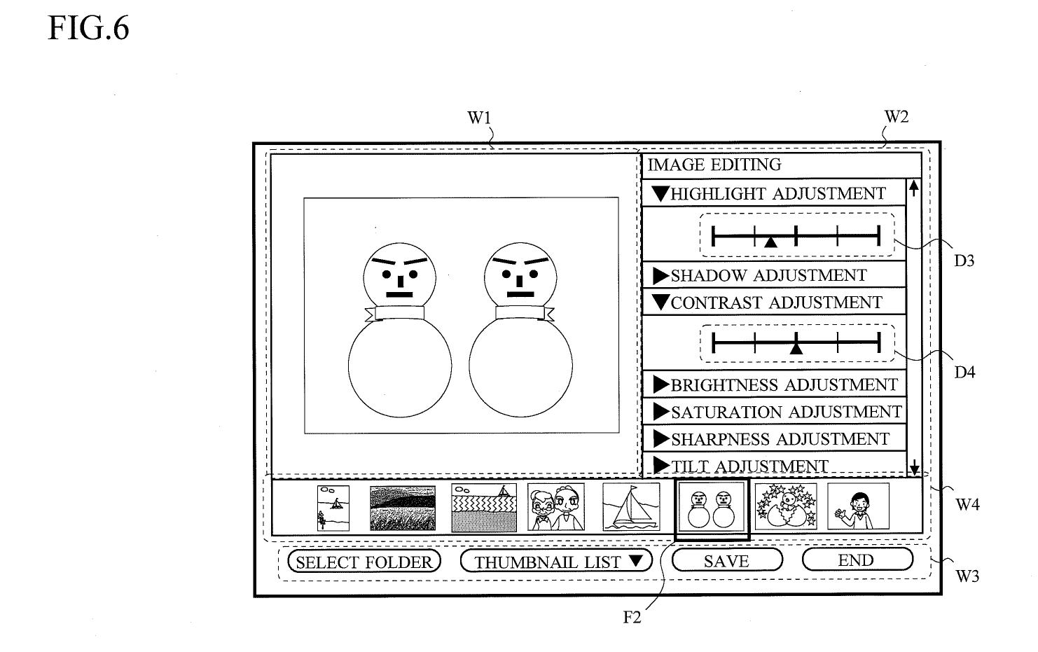

FIG. 6 illustrates an example of a user interface decided when distribution with regard to brightness is analyzed in the image analysis of step S104, and as a result of the analysis, the target image has many washed-out highlights and also has a large difference between the white level and the black level. Meanwhile, in FIG. 6, a frame F2 indicating an image selected as the target image among the plurality of thumbnail images displayed on the window W4 is displayed, and also the image selected as the target image is displayed on the window W1 in a magnified manner.

When the target image is an image having many washed-out highlights, image editing such as “highlight adjustment” or the like is frequently performed and effective as well. In addition, when the target image is an image having a large difference between the white level and the black level, image editing such as “contrast adjustment” is frequently performed and effective as well. Therefore, the UI decision part 24 selects a user interface capable of setting details of such items. FIG. 6 is a display example of a selected user interface. In the example of FIG. 6, there is displayed a slide bar D3 capable of setting the degree of highlight adjustment, and there is displayed a slide bar D4 capable of setting the degree of contrast adjustment. That is, the items “highlight adjustment” and “contrast adjustment” are in an opened state in the menu displayed on the window W2.

Meanwhile, the example of FIG. 6 illustrates a case where analysis of distribution with regard to brightness is performed, and as a result of the analysis, the target image is an image having many washed-out highlights, but it is preferable to select an user interface capable of setting details of the item “shadow adjustment” in place of “highlight adjustment” when, in contrast, the target image is an image having many flat shadows.

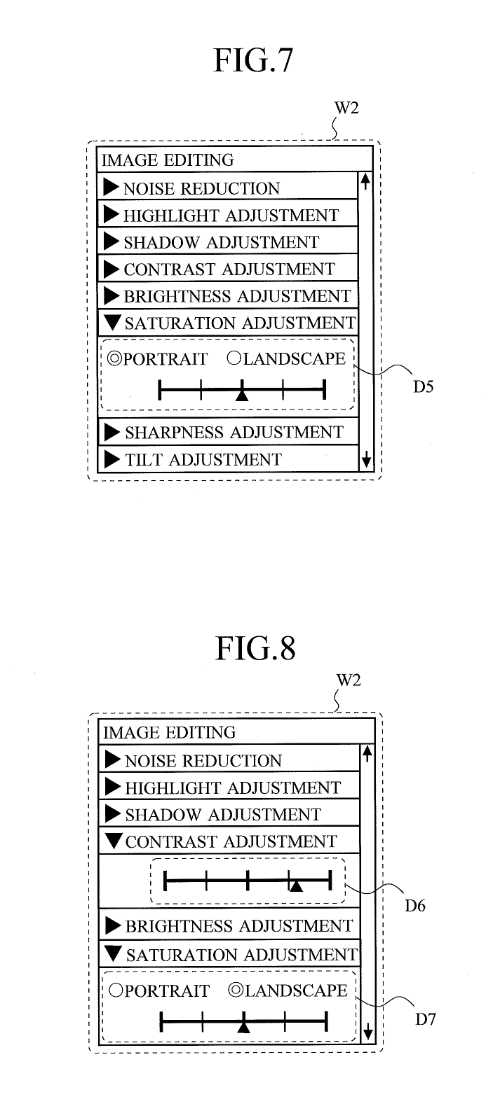

FIG. 7 illustrates an example of a user interface decided when, in the image analysis of step S104, face detection which detects a face region included in the target image is performed, and as a result of the analysis, the target image is an image including a person. Meanwhile, for simplicity, only the window W2 is illustrated in FIG. 7.

When the target image is an “image including a person”, image editing such as “saturation adjustment” is frequently performed and effective as well. Therefore, the UI decision part 24 selects a user interface capable of setting details of the item. FIG. 7 is a display example of the selected user interface. In the example of FIG. 7, there is displayed a slide bar D5 capable of setting the degree of saturation adjustment. That is, the item “saturation adjustment” is in an opened state in the menu displayed on the window W2. Meanwhile, when there is a selection item, relating to saturation adjustment, such as “person/scenery”, as illustrated in the example of FIG. 7, the UI decision part 24 preliminarily sets the “person” to a selected state as illustrated in FIG. 7.

Meanwhile, the example of FIG. 7 illustrates a case where face detection is performed, and as a result of the analysis, a user interface also capable of setting details of “saturation adjustment” is selected when the target image is an “image including a person”, but it is preferable to select an user interface also capable of setting details of such an item, when there exists an item such as “trimming (based on the result of the face detection)” on the menu displayed on the window W2.

In the following, a preferable user interface will be described (illustration being omitted) with regard to respective items of the attribute information obtained at step S102, the shooting conditions obtained at step S103, and the result of the image analysis performed at step S104.

<Concerning the Attribute Information Obtained at Step S102>

Data Format of the Target Image (RAW, JPEG, Etc.)

When the data format of the target image is RAW format, a user interface capable of setting details of an item suitable for an image before compression is selected from the menu displayed on the window W2. In contrast, when the data format of the target image is a format such as JPEG format, a user interface capable of setting details of an item suitable for an image after compression is selected from the menu displayed on the window W2.

Data Size of the Target Image

When the data size of the target image is relatively large, a user interface capable of setting details of an item with a light processing load is selected from the menu displayed on the window W2. In contrast, when the data size of the target image is relatively small, a user interface capable of setting details of an item with a heavy processing load is selected from the menu displayed on the window W2.

In addition, when the data size of the target image is relatively large, the selection may be performed similarly to the case where the data format of the target image described above is RAW format, and when the data size of the target image is relatively small, the selection may be performed similarly to the case where the data format of the target image described above is a format such as jPEG or the like.

<Concerning the Shooting Conditions Obtained at Step S103>

Type of Shooting Mode Set when the Target Image is Shot

For example, when the shooting mode described above is a night view mode, a user interface capable of setting details of an item such as “noise reduction” or “cross filter” is selected from the menu displayed on the window W2. In addition, when the shooting mode described above is a shooting mode related to shooting a person, such as the portrait mode, the selection is performed in the same way as the case described referring to FIG. 7. As to other shooting modes (scenery mode, sports mode, etc.), it suffices to select a user interface capable of setting details of a preferred item in the assumed main subject.

Exposure Conditions when the Target Image is Shot

When it can be determined based on exposure conditions that blurring or fuzziness is very likely to be generated in the target image, a user interface capable of setting details of an item such as “contrast adjustment” or “sharpness adjustment” is selected from the menu displayed on the window W2.

Presence or Absence of Flash Light Emission when the Target Image is Shot

When flash light emission is performed at the time of shooting, a user interface capable of setting details of an item such as “white balance” is selected from the menu displayed on the window W2.

Positional Information (GPS Information) when the Target Image is Shot

When there exists GPS information at the time of shooting, a user interface capable of setting details of displaying positional information or map information is selected (not illustrated in the menu displayed on the window W2).

External Device Connected to the Imaging Apparatus when the Target Image is Shot

When there exists information related to an external device connected to the imaging apparatus when the target image is shot, a user interface capable of setting details of a preferred item is selected from the menu displayed on the window W2, according to the type or operation state of the external device.

<Concerning the Result of the Image Analysis Performed at Step S104>

Analysis of Distribution with Regard to Brightness of the Target Image

Selection is performed in the same way as the case described referring to FIG. 5, based on the result of performing the analysis of distribution with regard to brightness.

Face Detection which Detects a Face Region Included in the Target Image

When the target image is an image including a person, as a result of performing face detection, selection is performed in the same way as the case described referring to FIG. 7.

Dust Detection with Regard to the Target Image

As a result of performing dust detection, when it is determined that there exists influence of dust on the target image, a user interface capable of setting details with regard to “removal of dust” (automatic removal, inquiring the user of necessity of dust removal) is selected (not illustrated in the menu displayed on the window W2).

Red-Eye Detection with Regard to the Target Image

When it is determined that there exists a red-eye part in the target image as a result of performing red-eye detection, a user interface capable of setting details relating to “red-eye correction” (automatic correction, inquiring the user of necessity of correcting the red-eye) is selected (not illustrated in the menu displayed on the window W2).

Blur Detection and Bokeh Detection with Regard to the Target Image

When it is determined that there are blurring and bokeh to the target image, as a result of performing blur detection and bokeh detection, a user interface capable of setting details of an item such as “sharpness” is selected from the menu displayed on the window W2. Alternatively, a user interface capable of setting details with regard to “blur correction” and “bokeh correction” (automatic correction, inquiring the user of necessity of respective corrections or the like) is selected (not illustrated in the menu displayed on the window W2).

Detection of Tilt Information with Regard to the Target Image

When the target image is inclined as a result of performing detection of tilt information, a user interface capable of setting details of an item such as “tilt adjustment” (automatic correction, inquiring the user of necessity of tilt adjustment or the like) is selected from the menu displayed on the window W2.

Meanwhile, the same also applies to the case where tilt information of the imaging apparatus at the time of shooting is included in the attribute information obtained at step S102.

Scene Analysis with Regard to a Subject Included in the Target Image

It suffices to assume a main subject included in the target image based on the result of performing the scene analysis, and to select a user interface capable to setting details of a preferable item for the assumed main subject from respective items described above.

Furthermore, the UI decision part 24 may decide contents of the user interface, based on the contents of image editing previously performed.

That is, every time image editing is performed, the CPU 14 records the contents as a history according to the target image. Then, the UI decision part 24 determines, in selecting a user interface capable of setting details of an item from the menu displayed on the window W2, whether or not there exists a history of image editing with regard to the item, and when there exists such a history, the UI decision part 24 decides the contents of the user interface based on the history.

FIG. 8 illustrates a display example of a user interface decided when there exists a history of image editing with regard to the item, in selecting a user interface capable of setting details. Meanwhile, for simplicity, only the window W2 is illustrated in FIG. 8.

In the example of FIG. 8, there is displayed a slide bar D6 capable of setting the degree of contrast adjustment, and there is displayed a slide bar D7 capable of selecting “person/scenery” with regard to the degree of saturation adjustment and of setting thereof. The UI decision part 24 decides the contents of the user interface based on the history of image editing in these D6 and D7. In FIG. 8, D6 indicates the degree in the previous image editing with regard to contrast adjustment. In addition, D7 indicates that “scenery” has been selected among the selection items “person/scenery”, and also indicates the degree of the previous image editing. Meanwhile, in the example of FIG. 8, the user interface may be decided so as to display only the items subjected to various settings in the previous image editing.

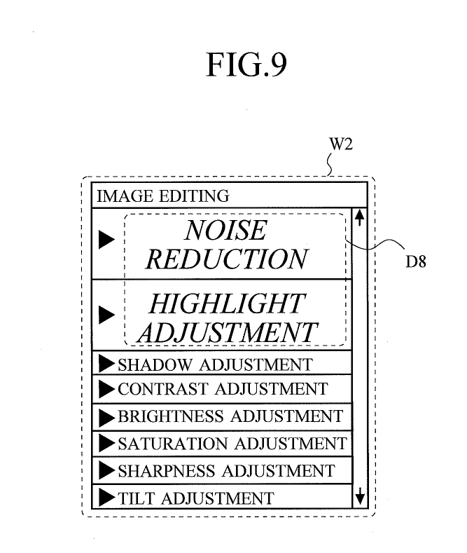

FIG. 9 illustrates a display example of a user interface in changing the display format of an item. Meanwhile, for simplicity, only the window W2 is illustrated in FIG. 9.

FIG. 9 illustrates an example of a case where there is performed display in which a display size is changed, as a display format of respective items of the user interface illustrated in FIG. 7. In the example of FIG. 9, the items of “noise reduction” and “highlight adjustment”, in which the image editing is frequently performed and effective as well, are displayed larger than other items, in D8. Meanwhile, although an example of changing the display size is described in the example of FIG. 9, as long as the items preferable for various settings are visible, the display color, font, frame thickness, or the like may be changed without changing the display size, or the display color, font, frame thickness, or the like may be changed in addition to changing the display size.

Meanwhile, when there is a plurality of factors (attribute information obtained at step S102, shooting conditions obtained at step S103, respective items of the result of the image analysis performed at step S104) for deciding the user interface, the UI decision part 24 decides the contents of the user interface after having performed weighting on the factors as appropriate. Weighting makes it possible to provide the plurality of factors with priority and to decide a user interface.

Weighting in this case may be predetermined, may be determined by the UI decision part 24 each time, or may be determined by the user. In performing weighting, the contents of the user interface may be decided based on the logical sum (OR) of a plurality of factors, or the contents of the user interface may be decided based on the logical product (AND).

In addition, among the plurality of factors, the contents of the user interface may be decided based on only some of the factors. On which factors the decision of the contents of the user interface is based may be decided according to the weighting and priority described above, may be decided by the UI decision part 24 each time, or may be decided by the user.

In addition, in deciding the contents of the user interface based on the plurality of factors, it is conceivable that settings of “respective items relating to image editing” described in FIG. 3 may be duplicative or contradictory due the plurality of factors. Accordingly, there may also be provided a configuration such that the user performs weighting on “respective items relating to image editing”.

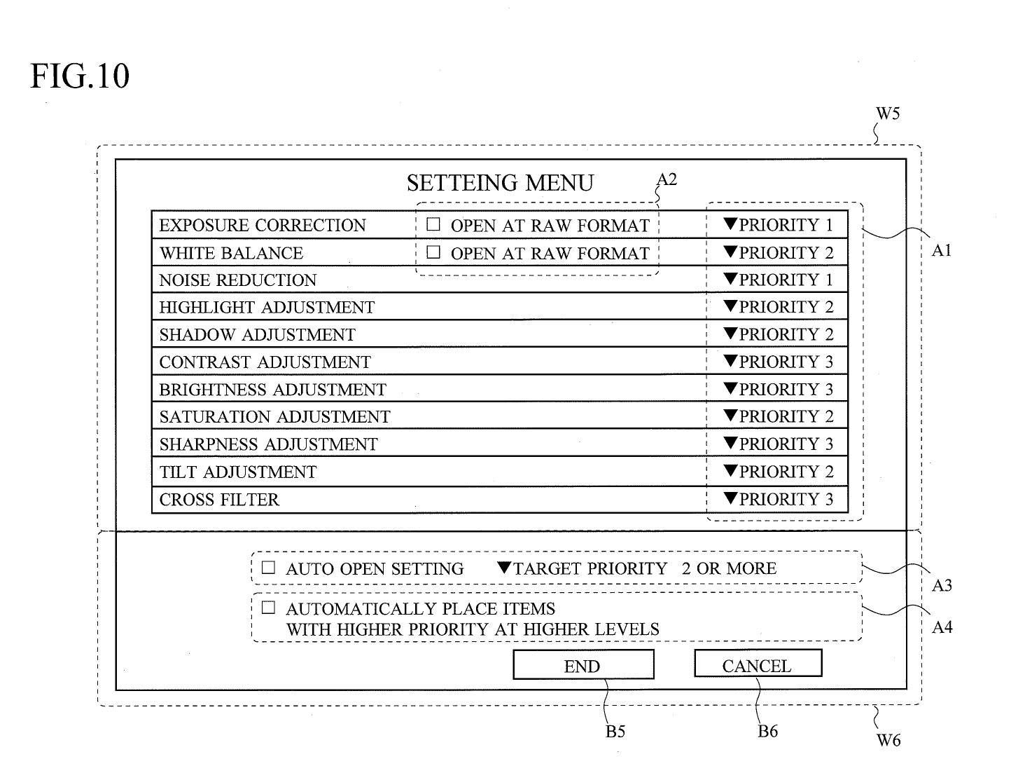

In the following, there will be described setting when the user performs weighting on “respective items relating to image editing”. FIG. 10 illustrates an example of a setting screen when the setting described above is performed based on user operation.

In the example of FIG. 10, a list of respective items relating to image editing is displayed on the first upper the window W5, and items relating to setting of weighting are displayed on the second window W6.

The user performs pull-down operation on a region A1 as to respective items in the window W5, and sets priority (for example, priority from 1 to 3). The priority can be set for each of the items displayed on the window W5. In addition, as to “exposure correction” and “white balance” among the respective items displayed on the window W5, a check box for allowing setting (for opening a menu) of details of the item without fail is always provided in a region A2, when the data format of the target image is RAW format in the attribute information obtained at step S102. The user can always perform setting of opening a menu of the item by checking the check box in the region A2 when the data format of the target image is RAW format.

Furthermore, in order to support the setting by the user, on what kind of images respective items relating to image editing act (what effect is caused on what image) may be displayed. For example, the following sentence may be displayed when the user brings the selecting cursor close to any of the respective items displayed on the window W5.
Exposure correction . . . “effective when the entire target image is too bright or too dark.”
White balance . . . “effective when color balance of the entire target image is uneven.”
Noise reduction . . . “effective when the target image is shot in a dark place.”
Highlight adjustment . . . “effective when there are many washed-out highlights in the target image.”
Shadow adjustment . . . “effective when there are many flat shadows in the target image.”
Contrast adjustment . . . “effective when contrast of the target image is not appropriate.”
Brightness adjustment . . . “effective when the entire target image is too bright or too dark.”
Saturation adjustment . . . “effective when the target image lacks vividness or when the color of the target image is saturated.”
Sharpness adjustment . . . “effective when the subject of the target image is blurred.”
Tilt adjustment . . . “effective when the target image is inclined.”
Cross filter . . . “effective when the target image is a night view image including a point light source.”

In addition, as described above, items relating to setting of weighting are displayed on the second window W6 at the lower part in the example of FIG. 10. Specifically, an item relating to automatic open setting (details will be described later) is displayed in a region A3, and an item relating to the arrangement of the items is displayed in a region A4. In addition, there are displayed an end button B5 for closing the setting menu after having performed a setting based on user operation, and a cancel button B6 for cancelling the setting.

Automatic open setting is a setting which allows (opens a menu for) automatic setting of details of any of the respective items displayed on the window W5, according to predetermined conditions. The automatic open setting is performed when the check box displayed in the region A3 is checked and a target priority is set by pull-down operation in the region A3. Predetermined conditions for automatic opening of each of the items displayed on the window W5 are described below.

Exposure Correction
When it is found, based on the attribute information obtained at step S102, that the data format of the target image is RAW format.
When it is found, based on the shooting conditions or the like obtained at step S103, that the value of an exposure correction value is large (when, for example, the EV value is equal to or smaller than −1.0 or equal to or larger than +1.0).
When it is found, based on the result of the image analysis (for example, histogram analysis, etc.) performed at step S104, that the level distribution in the target image is biased to the low level side or high level side.

White Balance
When it is found, based on the attribute information obtained at step S102, that the data format of the target image is RAW format.
When it is found, based on the shooting conditions or the like obtained at step S103, that a shooting mode other than “automatic shooting” has been set.
When it is found, based on the result of the image analysis (for example, histogram analysis) performed at step S104, that a large bias can be seen in the R, G, and B values in the target image.

Noise Reduction
When it is found, based on the shooting conditions obtained at step S103, that “night view mode” is set as the shooting mode.
When it is found, based on the shooting conditions obtained at step S103, that the exposure value is small due to a low shutter speed, or the like.
When it is found, based on the shooting conditions obtained at step S103, that the sensitivity (for example, ISO sensitivity) is set to a high sensitivity.

Highlight Adjustment
When it is found, based on the result of the image analysis (for example, histogram analysis) performed at step S104, that there are many high-level values distributed.

Shadow Adjustment
When it is found, based on the result of the image analysis (for example, histogram analysis) performed at step S104, that there are many low-level values distributed.

Contrast Adjustment
When it is found, based on the result of the image analysis (for example, histogram analysis) performed at step S104, that the difference between the white level and the black level is very small, or the foregoing difference is very large.

Brightness Adjustment
When it is found, based on the result of the image analysis performed at step S104, that the brightness value calculated from the target image is very small or very large.

Saturation Adjustment
When a person is recognized by face detection, based on the result of the image analysis performed at step S104.
When it is found, based on the result of the image analysis performed at step S104, that the saturation value calculated from the target image is very small or very large.

Sharpness Adjustment
When it is found, based on the shooting conditions obtained at step S103, that the shutter speed is a low speed.
When blur or bokeh is detected by blur detection or bokeh detection, based on the result of the image analysis performed at step S104.

Tilt Adjustment
When tilt is detected in the target image by detection of tilt information, based on the result of the image analysis performed at step S104.

Cross Filter
When it is found, based on the shooting conditions or the like obtained at step S103, that “night view mode” is set as the shooting mode.

Meanwhile, among the respective items, those having a plurality of conditions may be decided using only particular conditions (some of the conditions), or may be decided using all the conditions.

In addition, the target priority set in the region A3 of the window W6 described above is compared with the priority described in the region A1 of the window W5 and, based on the result of the comparison, it is determined whether or not the menu of the items is opened. For example, when the target priority is set “equal to or higher than priority 2” by pull-down operation in the region A3, no menu will be opened for an item for which the priority described in the region A1 of the window W5 described above is three.

In addition, as illustrated in FIG. 10, an item relating to the arrangement of items is displayed in the region A4 described above. When the check box of the item “automatically place items with higher priority at higher levels” is not checked, the displaying order “respective items relating to image editing” described in FIG. 3 remains in an initial state. In contrast, when the check box of the item “automatically place items with higher priority at higher levels” is checked, the items whose menu has been opened by the automatic opening setting described above are rearranged in descending order of priority.

Furthermore, as illustrated in FIG. 10, the end button B5 and the cancel button B6 are displayed on a setting menu. When the end button B5 is selected by the user, the setting screen is closed with the contents of various settings being stored. Moreover, when the cancel button B6 is selected by the user, setting screen is closed with the contents of various settings described above being discarded.

By deciding the user interface in this way, the user easily can know the contents of the previous image editing. Therefore, a highly convenient user interface can also be provided in performing fine adjustment or readjustment.

(Step S106)

Based on the user interface decided at step S105, the CPU 14 displays, on the monitor 19, a user interface according to the target image obtained at step S101.

The series of processing described above allows the CPU 14 to dynamically change the user interface displayed on the monitor 19, according to the target image.

Meanwhile, the processing by the CPU 14 after having dynamically changed the user interface is similar to a known technique. That is, the CPU 14 controls the image processing part 25 and performs image processing on the data of the target image obtained at step S101, based on editing instructions provided by user operation via the input device 18. Then, when the save button B3 displayed on the window W3 is selected, the CPU 14 stores, in the storage apparatus 13, data of the target image reflecting the result of the editing. In addition, the CPU 14 terminates image editing when the end button B4 displayed on the window W3 is selected.

A described above, according to the first embodiment, the contents of the user interface for accepting various settings for the target image to be displayed on the displaying apparatus is decided based on the target image to be displayed, and the user interface is displayed on the displaying apparatus based on the contents of the decision.

Therefore, according to the configuration of the first embodiment, it is possible to provide a user interface which is easy for the user to understand and use in displaying an image.

Particularly, according to the configuration of the first embodiment, it is possible to provide the user with a user interface including frequently-performed items or effective items, according to the target image, by dynamically changing the user interface according to the target image. Therefore, it is possible to implement a user interface which is sufficiently easy to understand and use even for users lacking knowledge and experience.

### Description of Second Embodiment

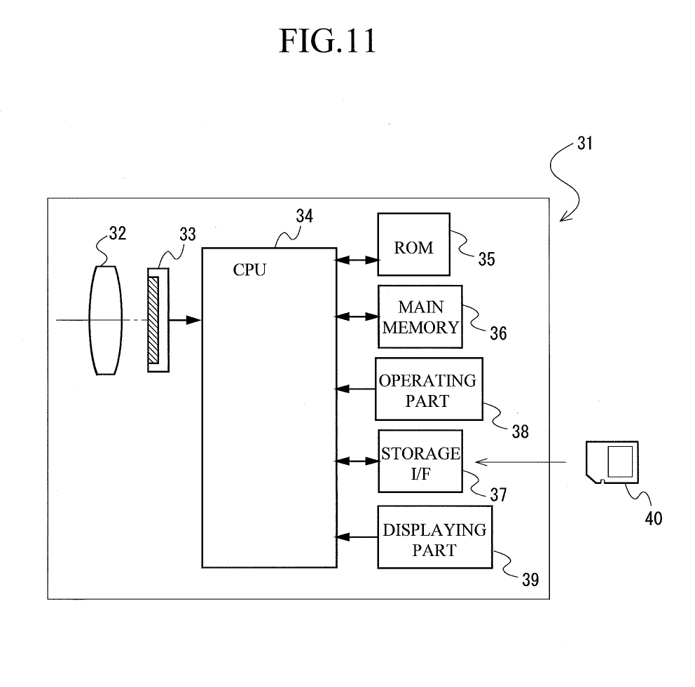

FIG. 11 is a block diagram illustrating a configuration example of an electronic camera in the second embodiment. An electronic camera 31 has an imaging optical system 32, an imaging element 33, a CPU 34, a ROM 35, a main memory 36, a recording I/F 37, an operating part 38 which accepts user operation, and a displaying part 39 having a monitor (not illustrated). Here, the imaging element 33, the ROM 35, the main memory 36, the recording I/F 37, the operating part 38, and the displaying part 39 are respectively connected to the CPU 34.

The imaging element 33 is an imaging device which captures an image of a subject formed by the imaging optical system 32, and generates an image signal of the captured image. Meanwhile, the image signal output from the imaging element 33 is input to the CPU 34 via an A/D conversion circuit (not illustrated).

The CPU 34 is a processor which controls the operation of the electronic camera 31 in an integrated manner. For example, the CPU 34 functions, by execution of a program, as a displaying apparatus (CPU 14, image analyzing part 23, UI decision part 24, image processing part 25) of the first embodiment described above.

The ROM 35 has a program stored therein to be executed by the CPU 34. In addition, the main memory 36 stores temporarily data of an image in the pre-processing or post-processing of the image processing.

The recording I/F 37 has a connector for connecting a nonvolatile storage medium 40 thereto. Then, the recording I/F 37 performs writing/reading of data to/from the storage medium 40 connected to the connector. The storage medium 40 described above includes a hard disk, a memory card having a built-in semiconductor memory, or the like. Meanwhile, in FIG. 11, a memory card is illustrated as an example of the storage medium 40.

The displaying part 39 displays the image data obtained from the CPU 34, as well as performing display described at step S106 of the first embodiment.

When a target image to be edited or displayed are selected by user operation via the operating part 38 in the electronic camera 31 of the second embodiment, the CPU 34 performs processing similar to those from step S101 to step S106 of the flow chart shown in in FIG. 2 of the first embodiment. Meanwhile, the CPU 34 may use, as the target image, an image generated by the imaging element 33, or may use, as the target image, an image recorded in the main memory 36, the storage medium 40, or the like. As thus described, the electronic camera 31 of the second embodiment can obtain an effect approximately similar to the above-described embodiment.

### Supplementary Note of the Embodiments

(1) Although description has been provided in the above-described respective embodiments on the assumption that a single image is selected as the target image, the present invention can be similarly applied to a case where a plurality of number of images is selected as target images. When the plurality of number of images is selected as the target image, it is convenient to display the thumbnail list described in FIG. 3.

When the plurality of numbers of images is selected as target images, the UI decision part 24 performs weighting as appropriate for each of the factors of the plurality of target images at step S105, or decides the contents of the user interface after having provided a plurality of the factors with priority. The weighting or priority in this case may be predetermined, may be decided by the UI decision part 24 each time, or may be decided by the user, similarly to the case described at step S105. In performing weighting as appropriate, the contents of user interface may be decided based on the logical sum (OR) of the plurality of the factors, or the contents of the user interface may be decided based on the logical product (AND) thereof.

(2) The contents of the user interface described in the above-described respective embodiments are each one example, and the present invention is not limited to the examples. At step S105, the UI decision part 24 decides, as the contents of the user interface, at least one of: type of items relating to various settings; displaying order items; arrangement of items; and display format of items. For example, the UI decision part 24 may select a user interface including only the items whose details can be set, or may select a user interface not including items whose details cannot be set. In addition, the UI decision part 24 may rearrange the displaying order of respective items described for the window W2 of FIG. 3 as appropriate, and decide the user interface so that frequently used and effective items are displayed at higher levels. Additionally, in the respective embodiments described above, respective items described for the window W2 of FIG. 3 may be separated into a plurality of sheets so that frequently used and effective items are placed on upper-layer sheets, whereas items which are neither frequently used nor effective are placed on lower-layer sheets.

Furthermore, the CPU 14 and the UI decision part 24 may be provided with a so-called learning function. Then, the UI decision part 24 may decide the user interface, based on frequency and experience with regard to setting of various items.

(3) Although description has been provided in the above-described respective embodiments by exemplifying a case of selecting an image to be edited as the target image, the present invention is not limited to this example. For example, the present invention can be applied similarly in selecting an image to be displayed as the target image.

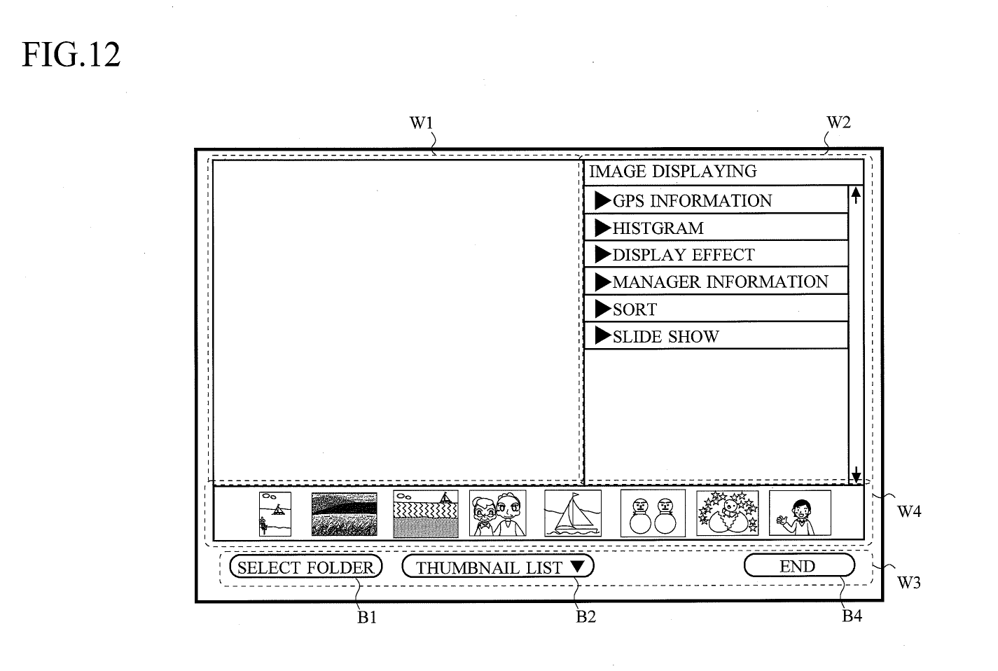

FIG. 12 illustrates a display example in selecting an image to be displayed as the target image. In the example of FIG. 12, the first window W1 is a window which displays the selected target image in a magnified manner, the second window W2 having displayed thereon a menu of respective items relating to displaying the image, third window W3 having various buttons displayed thereon, and the fourth window W4 having a plurality of thumbnail images displayed thereon. The user operates various buttons on the window W3 to display the plurality of thumbnail images on the window W4, and selects, via the input device 18, any image as the target image from the plurality of thumbnail images displayed on the window W4. Then, the selected target image is displayed on the window W1 in a magnified manner.

In the exemplary display of FIG. 12, respective items GPS information, histogram, display effect, manager information, sort, and slide show are illustrated as menu items displayed on the window W2. Then, the CPU 14 obtains, similarly to the case described referring to the flow chart of FIG. 2, attribute information at step S102, obtains shooting conditions at step S103, performs image analysis at step S104, and selects frequently used and effective items based on the respective factors to thereby decide a user interface at step S105.

(4) The displaying apparatus of the present invention is not limited to the examples of the displaying apparatus, computer, and electronic camera of the embodiment described above. The displaying apparatus of the present invention may be an electronic device (e.g., photo viewer, digital photo frame, printing apparatus of photographs) having reproduction display function and retouch function of digital images. In addition, the imaging apparatus of the present invention may be implemented as a camera module of a cellular phone terminal.

(5) Although description has been provided in the respective embodiments described above for an example for implementing each of the processing of the image analyzing part 23, the UI decision part 24, and the image processing part 25 as software, it is taken for granted that each of the processing is implemented as hardware by ASIC or the like.

(6) Although description has been provided in the above-described respective embodiments by exemplifying a case where operation is performed only inside a computer or an electronic camera, for an image existing on the computer or the electronic camera as the target image, the present invention is not limited to this example. For example, the present invention can be applied similarly not only to a case where data of the target image is a file existing in a physical folder, but also to a case where the data of the target image is data in a virtual folder managed by a database. Furthermore, in a case where data of the target image exists in a server located on a network and shared by a plurality of number of persons, the present invention may be configured such that software which operates in a local computer or an electronic camera to access the data via the network. In addition, assuming the use of a network, the invention may be software operating on a WEB server as a WEB application via the Internet.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1-14. (canceled)

15. A non-transitory storage medium storing a displaying program causing a computer to perform display control on a displaying apparatus, comprising:
reading a target image to be displayed;
selecting items for performing image editing on the target image and deciding a displaying content of a user interface for displaying the items being selected on the displaying apparatus; and
displaying the user interface on the displaying apparatus based on the displaying content.

16. The non-transitory storage medium storing the displaying program according to claim 1, wherein
in the deciding, due to appropriate degree as the items for image editing, at least one of a display order of the items, a display format including at least one of a display size and a display color, and a presence or an absence of detail display of the items is decided as the displaying content of the user interface.

17. The non-transitory storage medium storing the displaying program according to claim 1, wherein
in the deciding, the display content of the user interface is decided based on at least one of a factor being attribute information of the target image and a factor being a shooting condition when shooting the target image.

18. The non-transitory storage medium storing the displaying program according to claim 1, further comprising
performing an image analysis of the target image, wherein
in the deciding, the display content of the user interface is decided based on at least one of a factor being attribute information of the target image, a factor being a shooting condition when shooting the target image, and a factor being a result of the image analysis.

19. The non-transitory storage medium storing the displaying program according to claim 4, wherein
in the deciding, the factor is at least the result of the image analysis.

20. The non-transitory storage medium storing the displaying program according to claim 3, wherein
the attribute information includes at least one of a data format of the target image and a data size of the target image.

21. The non-transitory storage medium storing the displaying program according to claim 3, wherein
the shooting condition includes at least one of a type of shooting mode being set when shooting the target image, an exposure condition when shooting the target image, a presence or an absence of flash light emission when shooting the target image, positional information when shooting the target image, and information of an external device being connected to an imaging apparatus when shooting the target image.

22. The non-transitory storage medium storing the displaying program according to claim 4, wherein:
in the performance of the image analysis, performs at least one of a distribution analysis of brightness of the target image, a face detection detecting a face region included in the target image, a dust detection of the target image, a red-eye detection of the target image, a blur detection of the target image, a bokeh detection of the target image, a detection of tilt information of the target image, and a scene analysis of a subject included in the target image; and
the result of the image analysis includes at least one of distribution information of the brightness, a result of the face detection, a result of the dust detection, a result of the red-eye detection, a result of the blur detection, a result of the bokeh detection, the tilt information, and a result of the scene analysis.

23. The non-transitory storage medium storing the displaying program according to claim 1, wherein
in the deciding, when deciding the displaying content of the user interface based on a plurality of factors, the display content of the user interface is decided after having performed weighting on the plurality of the factors, in which the factors include at least one of a factor being attribute information of the target image and a factor being a shooting condition when shooting the target image.

24. The non-transitory storage medium storing the displaying program according to claim 1, wherein
the display content of the user interface being decided in the deciding is a display content of a user interface having preferred items for image editing which are visible by a user.

25. The non-transitory storage medium storing the displaying program according to claim 2, wherein
in the deciding, weighting is performed on the items and at least one of the display order of the items, the display format including at least one of the display size and the display color, and the presence or the absence of the detail display of the items is decided according to the weighting.

26. The non-transitory storage medium storing the displaying program according to claim 1, wherein
in the deciding, the display content of the user interface is decided based on a content of the image editing being performed previously.

27. A displaying apparatus comprising:
a displaying part displaying an image;
a reading part reading a target image to be displayed on the displaying part;
a decision part selecting items for performing image editing on the target image to be displayed on the displaying part based on the target image and deciding a displaying content of a user interface for displaying the items being selected on the target image; and
a display controlling part displaying the user interface on the displaying part based on the displaying content.
